(19) United States
(12) Patent Application Publication
(10) Pub. No.: US 2019/0064454 A1
(43) Pub. Date: Feb. 28, 2019

(54) GLASS-BASED FERRULE ASSEMBLIES AND COUPLING APPARATUS FOR OPTICAL INTERFACE DEVICES FOR PHOTONIC SYSTEMS

(71) Applicant: CORNING OPTICAL COMMUNICATIONS LLC, Hickory, NC (US)

(72) Inventor: Alan Frank Evans, Beaver Dams, NY (US)

(21) Appl. No.: 16/170,188

(22) Filed: Oct. 25, 2018

Related U.S. Application Data
(63) Continuation of application No. PCT/US17/29580, filed on Apr. 26, 2017.
(60) Provisional application No. 62/329,435, filed on Apr. 29, 2016.
(60) Provisional application No. 62/329,566, filed on Apr. 29, 2016.

(51) Int. Cl. G02B 6/42

(52) U.S. Cl. CPC G02B 6/423; G02B 6/425; G02B 6/4292; G02B 6/4236

(57) ABSTRACT

Ferrule assemblies and coupling apparatus as used to form optical interface devices for photonics systems are disclosed. The ferrule assemblies include a ferrule made of a glass substrate and a pair of spaced apart alignment members, which can be made of a glass or a polymer. The ferrule assembly supports an array of optical fibers. The coupling apparatus is incorporated into a photonic integrated circuit assembly that has optical waveguides and that includes spaced apart alignment members, which can also be made of a glass or a polymer. The ferrule assembly and the coupling apparatus have complementary alignment features that align the optical waveguides and the optical fibers when forming the optical interface device. The alignment members have a geometry that allows them to be used to form both the ferrule assemblies and the coupling apparatus.

### CROSS-REFERENCE To RELATED APPLICATIONS

This application is a continuation of International Application No. PCT/US17/29580, filed on Apr. 26, 2017, which claims the benefit of priority to U.S. Application Nos. 62/329,435 and 62/329,566, both filed on Apr. 29, 2016, the content of which is relied upon and incorporated herein by reference in entirety.

### FIELD

The present disclosure relates to integrated photonics, and in particular relates to glass-based ferrule assemblies and coupling apparatus for optical interfaces devices for photonic systems.

### BACKGROUND

Photonic systems are presently used in a variety of applications and devices to communicate information using light (optical) signals. Photonic systems may include photonic integrated circuits (PICs), which are analogous to electronic integrated circuits in that they integrate multiple components into a single material where those components operate using light only or a combination of light and electricity. A typical PIC has a combination of electrical and optical functionality, and can include light transmitters (light sources) and light receivers (photodetectors), as well as electrical wiring and like components that serve to generate and carry electrical signals for conversion to optical signals and vice versa.

A PIC includes one or more optical waveguides that carry light in analogy to the way metal wires carry electricity in electronic integrated circuits. Just as the electricity traveling in the wires of an electronic integrated circuit carries electrical signals, the light traveling in the waveguides of a PIC carries optical signals.

To transmit the optical signals from the PIC to a remote device, the optical signals carried by a waveguide in the PIC need to be transferred or “optically coupled” to a corresponding optical fiber connected to the remote device, This optical coupling should have a suitable optical efficiency and the optical coupling apparatus should have a compact footprint, as well as being low-cost and able to be reliably connected and disconnected. In addition, the optical coupling should be optically efficient even at relatively high operating temperatures since the PICs may generate significant amounts of heat. These relatively high operating temperatures may result in thermal expansion due to differences in the coefficients of thermal expansion (CTE) of the various components of the optical interface device and can adversely impact the optical coupling efficiency.

### SUMMARY

A first aspect of the disclosure is a ferrule assembly for optically coupling to a coupling apparatus of a PIC assembly. The ferrule assembly includes: a glass support substrate having opposite upper and lower surfaces, opposite sides, and opposite front and back ends; first and second alignment members having respective first and second long axes and that are attached to the upper surface and spaced apart about their long axes, the first and second alignment members having respective first and second alignment features that respectively operably engage with first and second complementary alignment features of the coupling apparatus; and an array of optical fibers disposed on the upper surface of the glass support substrate between the first and second support members, with the optical fibers running generally parallel to the first and second long axes and that extend from the back end of the support substrate, the optical fibers having end faces that reside substantially at the front end of the support substrate.

Another aspect of the disclosure is a PIC assembly configured to couple to a ferrule assembly. The PIC assembly includes: a PIC having an upper surface, a front end, and an array of optical waveguides, with each optical waveguide having an end face that resides substantially at the PIC front end; and first and second alignment members having respective first and second front ends and first and second long axes, the first and second alignment members being attached to the upper surface and spaced apart along the first and second long axes, the first and second alignment members having respective first and second alignment features that respectively operably engage with first and second complementary alignment features of the ferrule assembly.

Another aspect of the disclosure is a coupling apparatus for a PIC assembly that has a PIC having an array of optical waveguides, for coupling to a ferrule assembly having an array of optical fibers, The coupling apparatus includes: first and second glass alignment members having respective first and second long axes and that are attached to the upper surface of the PIC and spaced apart along the first and second long axes; and first and second alignment features formed in the first and second glass alignment members and that are configured to engage with respective first and second complementary alignment features of the ferrule assembly.

Another aspect of the disclosure is an optical interface device that includes the ferrule assembly and the PIC assembly configured to operably couple to each other.

Another aspect of the disclosure is a photonic system that includes the optical interface device, a printed circuit board to which the PIC assembly is electrically connected, and a remote device operably connected to at least one of the optical fibers of the ferrule assembly.

Additional features and advantages are set forth in the Detailed Description that follows, and in part will be readily apparent to those skilled in the art from the description or recognized by practicing the embodiments as described in the written description and claims hereof, as well as the appended drawings. It is to be understood that both the foregoing general description and the following Detailed Description are merely exemplary, and are intended to provide an overview or framework to understand the nature and character of the claims,

### BRIEF DESCRIPTION OF THE DRAWINGS

The accompanying drawings are included to provide a further understanding, and are incorporated in and constitute a part of this specification. The drawings illustrate one or more embodiments and together with the Detailed Description serve to explain principles and operation of the various embodiments. As such, the disclosure will become more fully understood from the following Detailed Description, taken in conjunction with the accompanying Figures, in which:

FIG. 1 is an elevated view of an example photonic system in an unmated state that includes an integrated photonic assembly having a PIC assembly that includes or is configured as a coupling apparatus for operably coupling with a ferrule assembly, wherein the PIC assembly and ferrule assembly define an optical interface device;

FIG. 2A is a close-up, front-on view of an example PIC assembly of the integrated photonic assembly of FIG. 1, wherein the PIC assembly includes a coupling apparatus defined by spaced apart alignment members;

FIG. 2B is a front elevated view of an example alignment member used to form the coupling apparatus of FIG. 2A;

FIG. 3A is similar to FIG. 2A and illustrates an example wherein the coupling apparatus includes a spacing feature that resides between the alignment members and on the upper surface of the PIC;

FIG. 3B is similar to FIG. 3A and illustrates example of an alignment feature in the form of small blocks that reside on the upper surface of the PIC and that serve to position and align the alignment members atop the PIC when forming the coupling apparatus;

FIG. 3C is similar to FIG. 3A and illustrates another example of the coupling apparatus that includes a support member that mechanically connects the alignment members at their respective top surfaces;

FIG. 3D is similar to FIG. 3C and illustrates an example of the coupling apparatus wherein the support member also includes a spacing feature for ensuring a select spacing between the alignment members;

FIG. 4A is a back-side elevated view of an example ferrule assembly according to the disclosure;

FIG. 4B is a partially exploded front-on view of an example ferrule assembly that includes a securing member for securing the optical fiber array to the upper surface of the support substrate;

FIG. 4C is a front elevated view of an example alignment member used to form the ferrule body of the ferrule assembly of FIG. 4A;

FIG. 4D is a close-up cross sectional view of an example optical interface device that shows a ferrule assembly operably mated to a PIC assembly, and illustrates an example of where the heights h′ and h of the alignment members used for the ferrule assembly and for the coupling apparatus are different to compensate for a fiber-to-waveguide offset in order to satisfy the fiber-to-waveguide alignment condition;

FIG. 4E is similar to FIG. 4B and shows the securing member operably disposed atop the optical fiber array;

FIG. 4F is similar to FIG. 4E and illustrates an embodiment wherein the optical fiber array spans the entire space between the alignment members;

FIG. 4G is similar to FIG. 4F and FIG. 4A and illustrates an example where the securing member has a height that is substantially the same as the height of the two spaced apart alignment members;

FIG. 4H is similar to FIG. 4F and illustrates an example where the securing member includes alignment features on its lower surface that serve to receive and align the optical fibers in the optical fiber array on the upper surface of the support substrate;

FIGS. 5A through 5E are front-on views of additional example configurations and features of the ferrule assembly disclosed herein;

FIG. 6A is similar to FIG. 1 and shows the photonic system with optical interface device operably connected in a mated state with the ferrule assembly optically coupled to the coupling apparatus of the PIC assembly; and

FIG. 6B is a close-up cross-sectional view of the operably connected optical interface device of the photonic system of FIG. GA as taken in a y-z plane along a waveguide of the PIC assembly and a corresponding optical fiber of the ferrule assembly, and shows how guided light generated in the PIC travels through the waveguide, across the interface between the coupling apparatus and the ferrule assembly and into the optical fiber, and then to a remote device.

### DETAILED DESCRIPTION

Reference is now made in detail to various embodiments of the disclosure, examples of which are illustrated in the accompanying drawings. Whenever possible, the same or like reference numbers and symbols are used throughout the drawings to refer to the same or like parts. The drawings are not necessarily to scale, and one skilled in the art will recognize where the drawings have been simplified to illustrate the key aspects of the disclosure.

The claims as set forth below are incorporated into and constitute part of this Detailed Description.

Cartesian coordinates are shown in some of the Figures for the sake of reference and are not intended to be limiting as to direction or orientation.

Methods of forming the glass-based ferrule assemblies, the PIC assemblies, the coupling apparatus and the optical interface devices, including the various components that make up these assemblies, sub-assemblies and devices are described in the aforementioned patent application, entitled “Methods of forming glass-based ferrules and glass-based coupling apparatus,” which as noted above is incorporated by reference herein in its entirety.

Photonic System and PIC Assembly

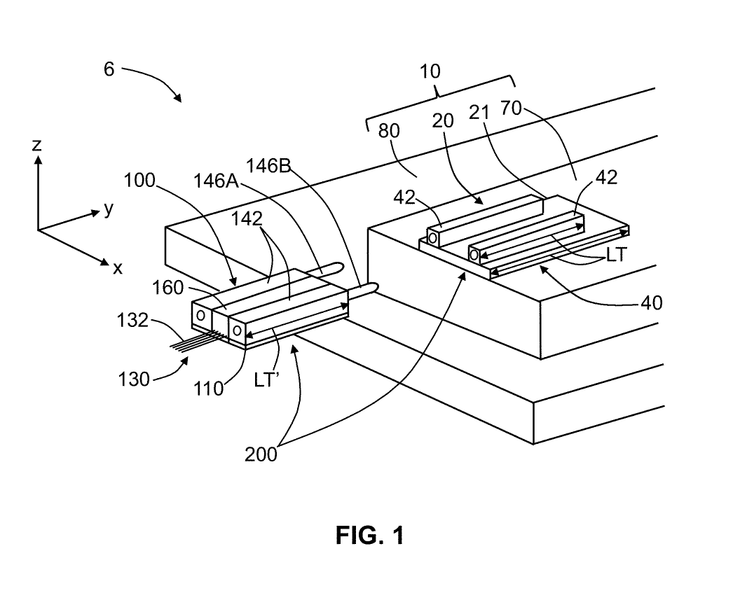

FIG. 1 is an elevated view of an example photonic system 6 in an unmated state. The photonic system 6 includes an integrated photonic assembly 10 and a ferrule assembly 100. The integrated photonic assembly includes alignment members 42 configured to be operably coupled to alignment members 142 of ferrule assembly 100 via complementary alignment features for making an optical connection therebetween. The integrated photonic assembly 10 includes a PIC assembly 20 shown mounted to an interposer substrate (“interposer”) 70, which is configured to provide electrical connections between PIC assembly 20 and a printed circuit board (PCB) 80, The PIC assembly 20 includes or is configured as coupling apparatus 40. The coupling apparatus 40 includes alignment members 42.

The coupling apparatus 40 is configured to operably couple to ferrule assembly 100 via respective alignment members 42 and 142 so that the ferrule assembly is in optical communication with PIC assembly 20 of integrated photonic assembly 10 when mated. The combination of PIC assembly 20 and ferrule assembly 100 define an optical interface device 200, which is shown as being disconnected in FIG. 1. The main components of photonic system 6 are now discussed in greater detail below.

PIC Assembly

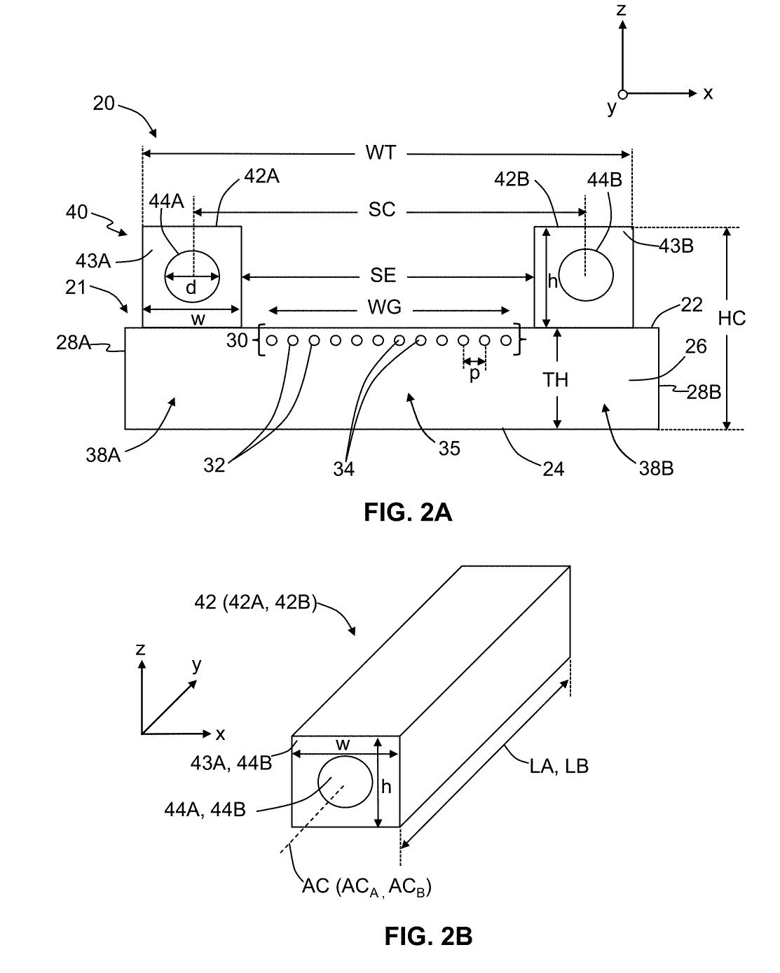

FIG. 2A is a close-up front-on view of an example PIC assembly 20. The PIC assembly 20 includes PIC 21, which has opposite upper and lower surfaces 22 and 24, a front end 26, opposite sides 28A and 28B, and supports an array 30 of optical waveguides (“waveguides”) 32 that run longitudinally in the x-direction along a medial portion 35 of the PIC 21. Each waveguide 32 has an end face 34 that terminates at front end 26. The end faces 34 may be disposed at any suitable location such as near lower surface 24, or near upper surface 22 as shown in FIG. 2A. In an example, waveguides 32 are made of glass. In an example, waveguides 32 comprise channel waveguides that comprise a core and a cladding for guiding the optical signal. Also in an example, waveguides 32 are single-mode, but other types of waveguides may be used with the concepts disclosed herein. Although, array 30 is depicted as a single-row for explanation purposes, the array 30 may comprise multiple rows if desired for use with the concepts disclosed.

The PIC 21 can also include other components that are not shown, such as photoemitters, photodetectors, metal wiring, optical redirecting elements, electrical processing circuitry, optical processing circuitry, contact pads, etc., as is known in the art. In an example, PIC 21 is formed mainly from silicon (i.e., is silicon-based) and constitutes a silicon photonics (SIP) device. In another example, PIC 21 is formed mainly from glass, i.e., is glass-based) and may constitute a passive planar lightwave circuit.

Example Coupling Apparatus

As noted above, in an example PIC assembly 20 includes coupling apparatus 40, which is configured to allow for the alignment of the optical coupling of the PIC assembly with ferrule 100, as introduced above and as described in greater detail below. The coupling apparatus 40 as described below is shown in the form of a receptacle having guide holes 44A and 44B configured to receive respective alignment pins 146A and 146B from ferrule assembly 100, as shown in FIG. 1 and as discussed below. Alternatively, the coupling apparatus 40 can also be configured as a plug by providing alignment pins 146A and 146B on the coupling apparatus 40 and leaving the ferrule assembly configured with guide holes 144A and 144B for receiving alignment pins. The alignment pins and guide holes represent one example of complementary alignment features, and coupling apparatus 40 and ferrule assembly 100 can have other configurations for the complementary alignment features.

The coupling apparatus 40 includes spaced apart alignment members 42, denoted 42A and 42B. The alignment members 42A and 42B are disposed on upper surface 22 of PIC 21 and are configured to receive alignment pins 146A and 146B of ferrule assembly 100. PIC 21 has alignment members 42A,42B attached thereto in a suitable manner so that a device such as ferrule 100 may be mated with the assembly for making an optical connection to the optical waveguides 32 of PIC 21, Using separate alignment members 42A,42B may be advantageous since they are easier to form with precision geometry than a monolithic component. Also by using individual alignment members and or components for the coupling apparatus 40 the impact due to the mismatch of CTEs of different materials (i.e., stress, strain and optical misalignment at elevated temperatures) may be reduced.

In an example, alignment members 42A and 42B reside on upper surface 22 atop respective side portions 38A and 38B of PIC 21 near sides 28A and 28B of PIC 21. In an example, alignment members 42A and 42B are attached (fixed) to upper surface 22 of PIC 21 using a suitable structure for the materials of the PIC 21 and the alignment members 42A, 42B. By way of explanation, alignment members 42A and 42B may be attached to PIC 21 using an adhesive, such as an epoxy (e.g., a UV-cured epoxy). In another example, if alignment members 42A and 42B are glass-based they may be attached (fixed) to PIC 21 using a thin absorbing film or thin film of low melting glass or a glass frit or by using direct glass bonding techniques known in the art.

Coupling apparatus 40 comprises alignment members 42A and 42B and a PIC coupling assembly comprises PIC 21 with a coupling apparatus 40 (comprising alignment members 42A and 42B) attached thereto. The coupling apparatus 40 provides a precision alignment registration to the optical waveguides 32 of PIC 21 with another device such as ferrule assembly 100 or the like. Consequently, it is advantageous to have a coupling assembly that allows a precise and repeatable method of manufacture for placing and securing the coupling apparatus 40 to PIC 21 relative to the optical waveguides 32.

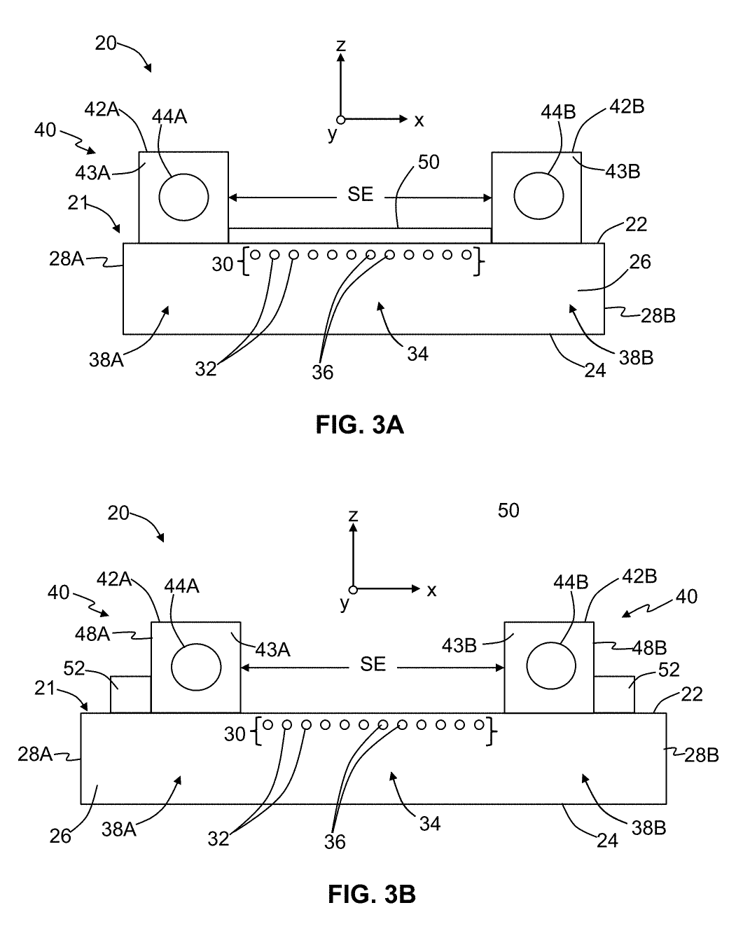

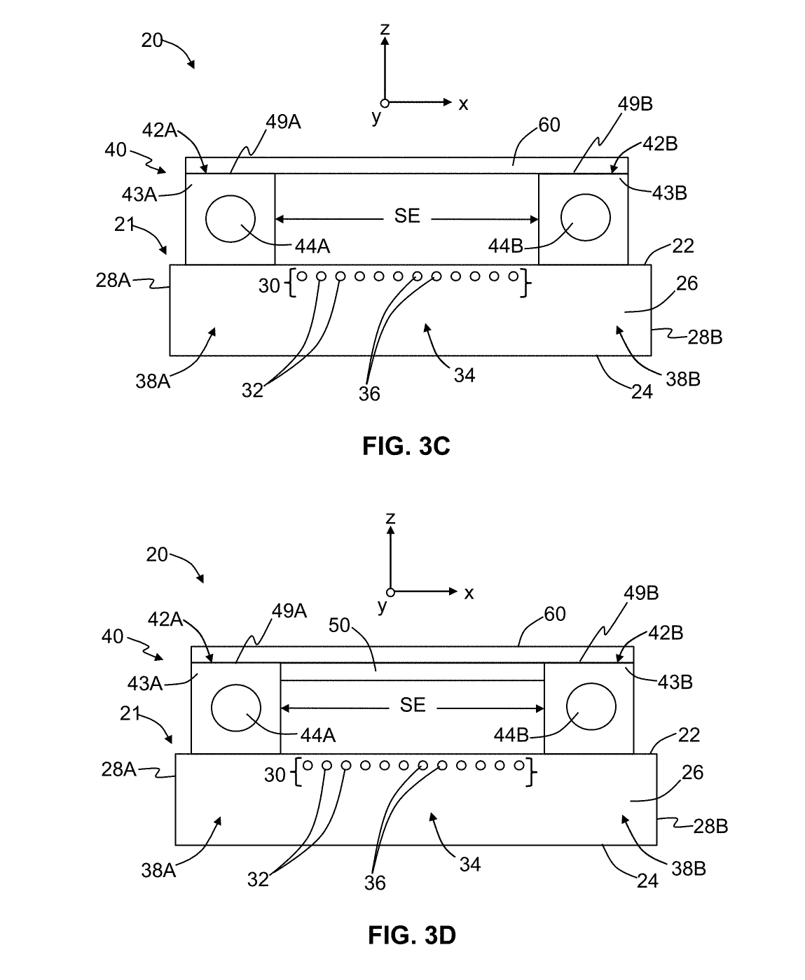

Variations of coupling apparatus 40 may include other structure or features that aids in placing and securing the coupling apparatus in a precise and repeatable manner according to the concepts disclosed herein. Several explanatory examples are briefly introduced and then described in more detail below. In a first example, coupling apparatus 40 may comprise alignment members 42A and 42B and alignment spacer 50 (FIG. 3A). In another example, coupling apparatus 40 may comprise of alignment members 42A and 42B and alignment features 52 (FIG. 3B). In still another example, coupling apparatus 40 may comprise of alignment members 42A and 42B, and a support structure 60 (FIG. 3C). In other variations of the concepts disclosed, the coupling apparatus may use any suitable combinations of structures or features disclosed such as for the coupling apparatus. For instance, coupling apparatus 40 may comprises of alignment members 42A and 42B, alignment spacer 50, and a support structure 60 (FIG. 3D).

In an example, alignment members 42A and 42B reside outside of medial portion 35 where array 30 of waveguides 32 resides. In one example, alignment members 42A and 42B are made a molded polymer (e.g., polyphenylene sulfide or PPS), while in another example the alignment members are made of glass, such as silica, PYREX® glass, or a chemically strengthened glass. One example of a chemically strengthened glass is GORILLA® glass, available from Corning, Inc., Corning, N.Y. Other chemically strengthened glasses can also be effectively employed.

FIG. 2B is a front elevated view of an example alignment member 42 with a central axis AC, illustrating an example in which the two alignment members 42A and 42B are similar. With reference to FIGS. 2A and 2B, alignment members 42A and 42B include respective longitudinal central axes AC_{A} and AC_{B} that run in the y-direction. The alignment members 42A and 42B also have respective front ends 43A and 43B and respective axial guide holes 44A and 44B that respectively run along or generally parallel to central axes AC_{A} and AC_{B} and that are open at the front ends. As used herein, the terms “parallel” or “generally parallel” means parallel within ±5 degrees. The guide holes 44A and 44B are configured to receive respective alignment pins 146A and 146B from ferrule assembly 100 and form a close fit thereto, thereby providing precision alignment of the optical channels upon mating. In one example, alignment members 42A and 42B are formed from a suitable glass material and may be formed using a glass-drawing process similar to a process used for drawing optical fibers for providing precision geometry, However, other manufacturing processes may be used depending on the materials selected for the coupling apparatus 40 and PIC 21.

Alignment members may have any suitable cross-sectional shape or size. In an example, guide holes 44A and 44B have a circular cross-sectional shape (x-z plane) to closely accommodate guide pins 146A and 146B that in an example also have a circular cross-sectional shape, Other cross-sectional shapes for guide holes 44A and 44B can be used consistent with the cross-sectional shapes of alignment pins 146A and 146B. Also in an example, alignment members 42A and 42B have a substantially rectangular (x-z plane) cross-sectional shape of height and width dimensions h and w, and further in an example have a substantially square cross-sectional shape, i.e., h=w. In another example, the cross-sectional shape of alignment members 42A and 42B have an aspect ratio h:w of no greater than 1:5 or 5:1, while in another example have an aspect ratio of no greater than 1:2 or 2:1, In another example, the aspect ratio h:w is substantially 1:1. In an example, the edges of alignment members 42A and 42B need not be perfectly square, e.g., they can be rounded.

In an example, dimensions h and w are each in the range from 350 microns to 1500 microns, while in another example are each in the range from 600 microns to 650 microns, with exemplary values being nominally h=w=625 microns. Alignment members 42A and 42B also have respective lengths length LA and LB, which in an example are in the range from 2 millimeters (mm) to 12 mm, or 2 mm to 4 mm, with an exemplary lengths LA and LB being equal and nominally 3 millimeters.

With reference again to FIG. 2A, alignment members 42A and 42B have a center-to-center spacing SC when secured to PIC 21 along with a precise location relative to the optical waveguides 32. Generally speaking, the center-to-center spacing SC is based upon the size and pitch of the optical waveguides 32 of the PIC along with the number of optical channels in array 30 and arrangement of the optical waveguides 32 of the array 30. In an example, spacing SC may be between 2 mm and 10 mm, with an exemplary spacing between 2 and 3 mm, e.g., 2.3 mm. The alignment members 42A and 42B also have an inside edge-to-edge spacing SE of between 1 mm and 5 mm, or between 1.5 mm and 2 mm, with an exemplary spacing SE of nominally 1.675 mm.

The array 30 of waveguides 32 also has a width WG. By way of example, an array 30 of n=12 optical waveguides 32 with a pitch p=127 microns is WG=(n)(p)=(12)×(127)=1524 microns. Other suitable values for the pitch p can be used, e.g., 125 microns or 250 microns, and in an example the number n of waveguides 32 can be from n=2 to n=24, but other suitable values are possible. For n=12 and a pitch p=250 microns, WG can be about 3 millimeters. In an example, WG is as large as 5 millimeters. In an example, PIC 21 has a thickness TH of between 300 and 1000 microns, or in another example is between 500 microns and 800 microns, with an exemplary thickness TH being nominally 750 microns.

Thus, in an example, coupling apparatus 40 has an overall or total width height HT, a total or overall width WT and a total or overall length LT (see FIG. 1). In an example, the overall length LT is defined by the overall lengths LA, LB of alignment members 42, while in another example the overall length is defined as the length of PIC 21 (see FIG. 1), or by an outer cover or housing (not shown).

In one example, the overall width WT is in the range from 2.5 mm to 7 mm, while in another example is in the range from 2.5 mm to 3.5 mm, with an exemplary value being about 3 mm. However, the coupling apparatus may have any suitable size, shape or dimension.

Also in an example, the overall or total height HT of coupling apparatus 40 is equal to height h, which as discussed above can have exemplary value of h=625 microns. In an example, the total height HT can include thickness TH of PIC 21 and can be in the range from 350 microns to 3500 microns (i.e., from 0.3 mm to 3.5 mm). In one example, the overall length LT of coupling apparatus 40 is LT=LA=LB, while in another example, the overall length LT>LA, LB and is defined by the length of PIC 21.

In an example, coupling apparatus 40 can have a size that is about half the size of a standard MT connector and can range from about that size to about the same size as a standard MT connector. Thus, in one example, the overall dimensions height HT, width WT and length LT of coupling apparatus 40 are about the same as that for a standard MT connector, e.g., HT×WT×LT=3 mm×7 mm×8 mm, or can be about half the size, e.g., 1.5 mm×3.5 mm×4 mm. In an example, the dimensions HT×WT×LT can be in the range from 5 mm×15 mm×20 mm to 1 mm×3 mm×2 mm; however, any suitable dimension may be used with the concepts disclosed. In an example, PIC assembly 20 has the dimensions HT×WT×LT.

FIG. 3A is similar to FIG. 2A and illustrates an example wherein coupling apparatus 40 further comprises an alignment spacer 50 that resides between alignment members 42A and 42B and on upper surface 22 of PIC 21. The alignment spacer 50 is formed to have a length defined to be the select edge spacing SE required to operably couple to ferrule assembly 100 (i.e., the alignment spacer matches the distance so the holes and alignment pins have the same spacing). The alignment spacer 50 acts a jig to control the spacing between alignment members 42A and 42B during manufacturing. The alignment spacer 50 can be formed from any suitable material such as a glass or a polymer, and can be secured to upper surface 22 of PIC 21 using the same techniques discussed above that can be used to fix alignment members 42A and 42B.

FIG. 3B is similar to FIG. 3A and illustrates another example of a coupling apparatus 40 that comprises alignment features 52 that reside on upper surface 22 of PIC 21. In FIG. 3B, the alignment members 42A and 42B have respective outer sides 48A and 48B closest to opposite sides 28A and 28B, respectively, of PIC 21. In the example, alignment features 52 are in the form of small blocks (i.e., smaller than alignment members 42A and 42B). The alignment features 52 can be used to facilitate proper spacing, placement and relative alignment of the alignment members 42A and 42B on the upper surface 22 of PIC 21 (e.g., relative to waveguide array 30). Alignment features 52 act as stops for alignment members 42A,42B on the outboard sides . The alignment features 52 can be formed from any suitable material such as a glass or a polymer and can be secured to upper surface 22 of PIC 21 and to alignment members 42A and 42B using the same techniques discussed above that can be used to fix alignment members 42A and 42B to the upper surface.

FIG. 3C is similar to FIG. 3A and illustrates another example of coupling apparatus 40 that includes a support structure 60 that mechanically connects alignment members 42A and 42B, which are shown in FIG. 3C to have top surfaces 49A and 49B, respectively. The support structure 60 resides on top surfaces 49A and 498 and spans the gap that separates the two alignment members 42A and 42B, thereby forming a bridge between the two alignment members. The support structure 60 serves to provide the desired spacing and additional structural support for coupling apparatus 40. In an example, alignment spacer 50 can be used in combination with or incorporated into support structure 60, as shown in FIG. 3D. The support structure 60 can be formed from any suitable glass or a polymer material and can be secured to top surfaces 49A and 40B using the same techniques discussed above that can be used to fix alignment members 42A and 42B to the upper surface 22 of PIC 21. In another variation, the support structure 60 may be formed with an integrally formed spacer feature by having outboards ledges formed in the support structure for the precision alignment and placement of the alignment members 42A, 42B on relative to the support structure.

In one example, coupling apparatus 40 as disclosed herein is glass-based, i.e., at least a portion of the coupling apparatus is made of at least one type of glass. In another example, coupling apparatus 40 is polymer-based, i.e., a portion of the coupling apparatus is made of at least one type of polymer, or a combination of glass and polymer as part of a “hybrid” configuration. For example, alignment members 42A and 42B can be made of a polymer while the other components, such as the alignment spacer 50, the alignment feature(s) 52 and/or the support structure 60, can be made of glass (i.e., a so-called “hybrid” configuration), Coupling apparatus 40 formed from glass-based materials may be advantageous since they can be formed with a precise geometry, which is advantageous for optical alignment and coupling. Moreover, the glass-based materials may have a CTE that is closer match to CTE of the PIC 21.

In another example configuration, alignment members 42A and 42B can be made of either a polymer or a glass. In an example, coupling apparatus 40 is made of a single type of glass, all of the components of the coupling apparatus are made of the same glass material. In another example, coupling apparatus 40 is made entirely of glass, but at least some of the components are made of different glass materials—for example, the alignment members 42A and 42B are made of a first glass material while all of the other components are made of a second glass material. In an example of coupling apparatus 40 that includes PIC 21, the coupling apparatus is hybrid, with PIC 21 being silicon based while alignment members 42A and 42B can be made of either a glass or a polymer.

Example Ferrules and Ferrule Assemblies

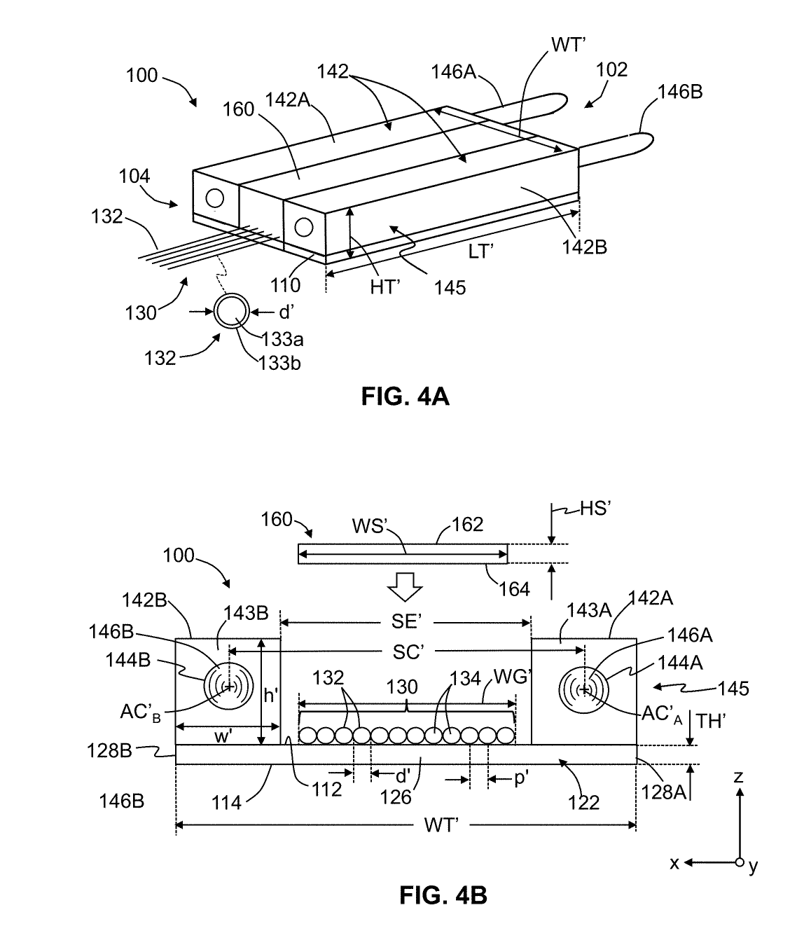

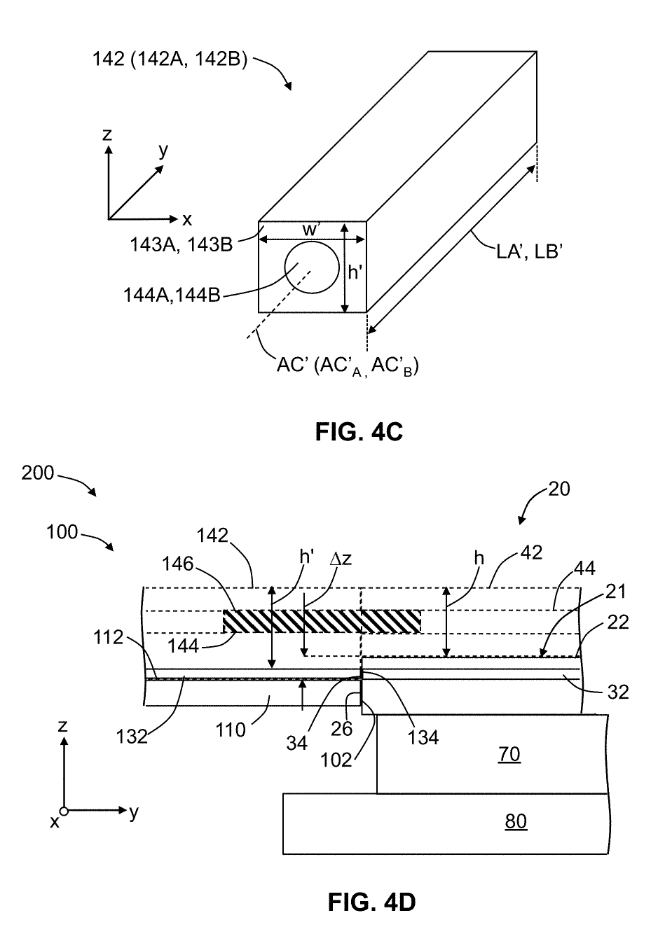

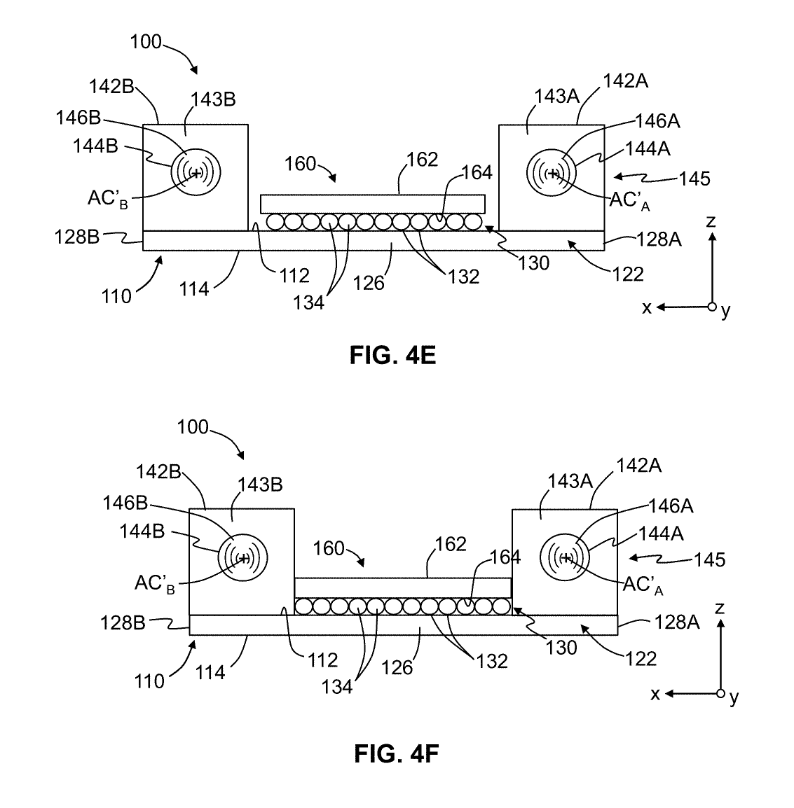

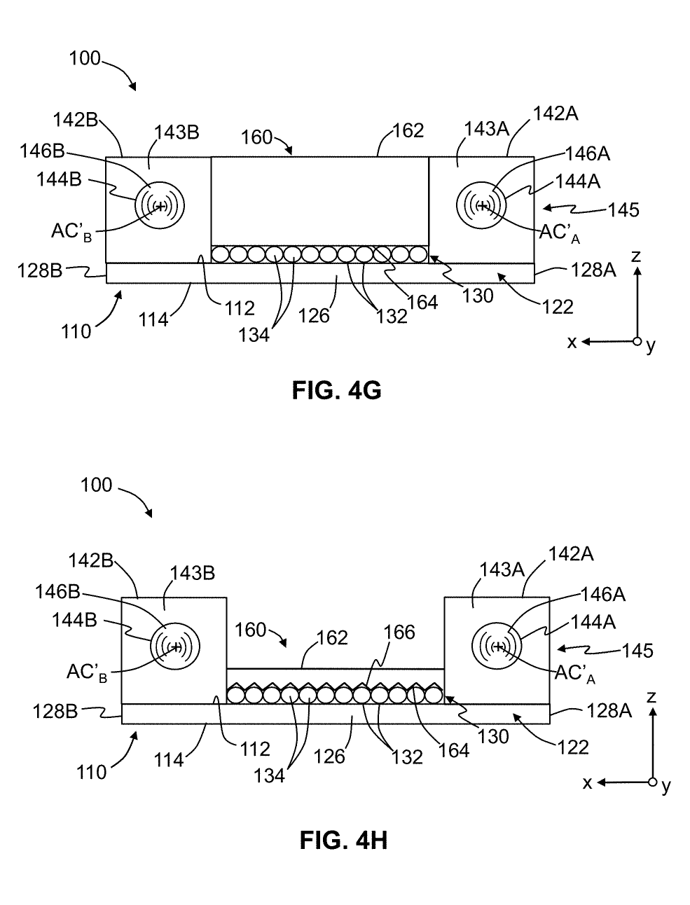

As discussed above, optical interface device 200 includes ferrule assembly 100, which is configured to mate to and optically couple to coupling apparatus 40 of PIC assembly 20. FIG. 4A is a back-side elevated view and FIG. 4B is a partially exploded front-on view of the example ferrule assembly 100. FIG. 4C is similar to FIG. 2B and is an elevated view of an example alignment member 142 used to form ferrule assembly 100

With reference now to FIGS. 4A through 4C, ferrule assembly 100 has a front side or front end 102 and a back side or back end 104. The ferrule assembly 100 includes a support substrate 110, that can have any suitable geometry. Generally speaking, support substrate has generally parallel upper and lower surfaces 112 and 114, opposite front and back ends 122 and 124, a central portion 126, and opposite edges (sides) 128A and 128B. In an example, support substrate 110 is in the form of a generally planar sheet and is made of any suitable material. By way of example, support substrate may be a glass, such as a float glass or a fusion-drawn glass, which could be chemically strengthened glass if desired. Although, the term “planar” is used, the support substrate 110 may include fiber alignment features such as V-grooves or other geometry for aligning and fixing the optical fibers in a desired spacing. For instance, the support substrate 110 may have the fiber alignment features etched into the surface for seating and spacing the optical fibers. The support substrate 110 has a thickness TH′. The ferrule assembly has a total or overall width WT′, a total or overall length LT′ and a total or overall height HT′.

The ferrule assembly 100 includes an array 130 of optical fibers 132 each having core 133a, a cladding 133b surrounding the core (see close-up inset in FIG. 4A), and an end face 134. The optical fibers 132 reside on upper surface 112 of substrate 110 at central portion 126 and run in the y-direction. In an example, fiber end faces 134 are terminated near the front end 122 of support substrate 110. The optical fibers 132 in array 130 define a pitch p′. In an example, optical fibers 132 each have a diameter d′, which in one example is 125 microns. In an example, optical fibers 132 are arranged side-by-side so that the optical fiber pitch p′ of array 130 is substantially equal to the fiber diameter d′. In another example, the optical fiber pitch p′ is 250 microns. In an example, optical fibers 132 are single-mode fibers, but other types of optical fibers may be used with the concepts disclosed. Also in an example, optical fibers 132 are small-clad optical fibers, i.e., the cladding 133b of optical fiber 132 is substantially smaller than that of the cladding used in a conventional optical fiber.

By way of explanation, a standard single-mode optical fiber can have a core diameter of about 10 microns and a cladding diameter ranging from 50 microns up to 125 microns. An advantage of using small-clad optical fibers for optical fibers 132 is that the pitch p′ can be made smaller than for conventional optical fibers, and can be made as small as the diameter d′ of the optical fiber, where the diameter d′ is defined by the diameter of cladding 133b. Thus, small-clad optical fibers 132 can be more densely packed in ferrule assembly 100 while also affording greater latitude in matching the period p′ of the optical fibers to the period p of waveguides 32 of PIC assembly 20. Although ferrule assembly 100 is depicted with a single-row of optical fibers, the ferrule assembly 100 may have multiple rows of optical fibers to mate with a suitable PIC coupling assembly 20.

The ferrule assembly 100 also includes first and second spaced apart alignment members 142, denoted 142A and 142B. As noted above, FIG. 4C is an elevated view of an example alignment member 142, which can be used as alignment members 142A and 142B.

The alignment members 142A and 142B are disposed on upper surface 122 adjacent respective sides 128A and 128B. In an example, alignment members 142A and 142B are formed using a drawing process similar if not identical to that used to draw optical fibers. In an example, alignment members 142 are similar to alignment members 42. In other examples, alignment members 142 can be formed using a molding process, a 3D printing process or an extrusion process.

The alignment member 142 has a central axis AC, and alignment members 142A and 142B include respective central axes AC_{A} and AC′_{B} that run in the y-direction. The alignment members 142A and 142B also have respective front ends 143A and 143B and include respective axial guide holes 144A and 144B that in an example run along or parallel to the central axes AC′_{A} and AC′_{B}. The axial guide holes 144A and 144B respectively contain alignment pins 146A and 146B that extend in parallel from respective front ends 143A and 143B. The alignment pins 146A and 146B are configured to be received by respective guide holes 44A and 44B of alignment members 42A and 42B of coupling apparatus 40 so that ferrule assembly 100 can operably couple to the coupling apparatus. Consequently, the operable coupling results in the connection of optical interface device 200, with optical fibers 132 of the ferrule assembly being axially aligned with corresponding waveguides 32 of PIC 21 of PIC coupling assembly 20. In an example, alignment pins 146A and 146 are made of a metal.

In an example, alignment pins 146A and 146B have a circular cross-sectional shape (x-z plane). Other cross-sectional shapes can be used consistent with the cross-sectional shape of guide holes 44A and 44B of alignment members 42A and 42B. Also in an example, alignment members 142A and 142B have a rectangular (x-z plane) cross-sectional shape of dimensions h′ and w′, and further in an example has a substantially square cross-sectional shape, i.e., h′=w′. In another example, the cross-sectional shape of alignment members 142A and 142B have an aspect ratio h′:w′ of no greater than 1:5 or 5:1, while in another example the aspect ratio is no greater than 1:2 or 2:1. In another example, the aspect ratio h′:w′ is substantially 1:1.

In an example, alignment members 142A and 142B are fixed to upper surface 112 of support substrate 110 using an adhesive, such as an epoxy (e.g., a UV-cured epoxy). In another example, alignment members 142A and 142B are fixed to upper surface 112 using a thin absorbing film or thin film of ow melting glass or a glass frit or by using direct glass bonding techniques known in the art. The alignment members 142A and 142B and the support substrate 110 define a ferrule body (“ferrule”) 145. In an example, ferrule 145 can include securing member 160, introduced and discussed below.

In an example, alignment members 142A and 142B reside outside of center portion 126 where array 130 of waveguides 32 resides. In one example, alignment members 142A and 142B are made of a molded polymer (e.g., polyphenylene sulfide or PPS), while in another example the alignment members are made of glass, such as silica, PYREX® glass, or a chemically strengthened glass. One example of chemically strengthened glass is GORILLA® glass, available from Corning, Inc., Corning, N.Y. Other chemically strengthened glasses can also be effectively employed.

In one example, dimensions h′ and w′ are each in the range from 300 microns to 2000 microns, while in another example are each in the range from 600 microns to 650 microns, with exemplary values being nominally h′=w′=625 microns. The alignment members 142A and 142B also have respective lengths length LA′ and LB′, which in one example are each in the range from 2 millimeters (mm) to 12 mm, while in another example are each in the range from 2 mm to 4 mm, with an exemplary lengths LA′ and LB′ being equal and nominally 3 millimeters. However, the concepts disclosed herein may be practiced with devices of any suitable size.

With reference to FIG. 4B, alignment members 142A and 142B have any suitable a center-to-center spacing SC′ for mating with the desired PIC, By way of example, the center-to-center spacing SC′ of between 2 mm and 10 mm, while in another example are in the range from 2 mm to 3 mm, with an exemplary spacing being 2.3 mm. The alignment members 142A and 142B also have an inside edge-to-edge spacing SE′ of between 1.5 and 5 mm, or between 1.5 mm and 2 mm, with an exemplary spacing SE′ of nominally 1.675 mm.

The array 130 of optical fibers 132 also has a width WG′, which in an example for an array of n′=12 optical fibers with a pitch p′=127 micron is WG′=(n′)(p′)=(12)×(127)=1524 microns. Other values for the pitch p′ can be used, e.g., 125 microns or 250 microns, and in an example the number n′ of optical fibers 132 can be from n=2 to n=24. For n′=12 and a pitch p′=250 microns, WG′ can be about 3 mm. In an example, WG′ is as large as 5 mm. In an example, support substrate 110 a thickness TH′ of between 300 and 2000 microns, or in another example is between 500 microns and 1000 microns, with an exemplary thickness TH′ being nominally 700 microns.

The array 130 of optical fibers 132 of ferrule assembly 100 is configured to optical couple to array 30 of waveguides 32 when ferrule assembly 100 is operably coupled to coupling apparatus 40 of PIC coupling assembly . Thus, in an example, the optical fiber pitch p′ is equal to the waveguide pitch p, and the number n′ of optical fibers 132 is equal to the number n of waveguides 32.

In one example, the overall width WT′ is in the range from 2.5 mm to 7 mm, while in another example is in the range from 2.5 mm to 3.5 mm, with an exemplary value being about 3 mm. In an example, the overall dimensions HT′, WI′ and LT′ of ferrule assembly 100 are about the same as that for a standard MT connector, e.g., HT′×LT′=3 mm×mm×8 mm, or can be about half the size, e.g., 1.5 mm×3.5 mm×4 mm. In an example, the dimensions HT′×WT′×LT′ can be in the range from 3 mm×7 mm×8 mm to 1.5 mm×3.5 mm×4 mm.

In an example, the height h′ of alignment member 142 is not the same as the height h of alignment member 42. This is because in some cases, these two heights need to be different in order for optical fibers 132 of ferrule assembly 100 to align with the optical waveguides 32 of PIC assembly 40 when the alignment pins 146 are inserted into alignment holes 44. This is referred to as the fiber-to-waveguide alignment condition, and arises due to an offset Δz between optical fibers 132 and waveguides 32 when the upper surface 112 of support substrate 110 and the upper surface 22 of PIC 21. reside in the same plane. This offset is referred to herein as the fiber-waveguide offset Δz.

FIG. 4D is a close-up cross-sectional view of an example optical interface device 200 that shows ferrule assembly 100 operably mated with PIC assembly 40 and illustrates an example of where the height h′ is greater than the height h. The alignment members 42 and 142 are shown in phantom since they would not otherwise appear in a cross-sectional view that includes waveguides 32 and optical fibers 132. The different heights h and h′ account for the offsets in the upper surface 112 of support substrate 110 and the upper surface 22 of PIC 21.

Thus, in an example, alignment members 42 and 142 have the same cross-sectional geometry but are rotated by 90 degrees relative to each other when attached to their respective surfaces 22 and 112. In other words, in an example, the height h′, the width w′ and the location of guide hole 144 are selected so that the alignment member 142 can be used in one orientation in ferrule 145 to form ferrule assembly 100 and in another orientation to serve as alignment member 42 on PIC 21 to form coupling apparatus 40. In an equivalent manner, in an example the height h, the width w and the location of guide hole 44 are selected so that the alignment member 42 can be used in one orientation on PIC 21 to form coupling apparatus 40 and in another orientation to serve as alignment member 142 for ferrule 145 of ferrule assembly 100. Thus, in an example, alignment member 42 or 142 can be a “dual use” alignment member, i.e., it can be used for either ferrule assembly 100 or coupling apparatus 40.

In another example, h=h′ but the distance between central axis AC′ and upper surface 112 for ferrule assembly 100 is made larger than the distance between central axis AC and upper surface 122. This can be accomplished by adjusting the locations of either guide holes 44 of alignment member 42 or guide holes 144 of alignment member 44.

In an example, alignment members 42 or 142 can be configured with a rectangular cross-sectional shape wherein h′=w and h=w′, and with h′ greater than h, to compensate for the fiber-waveguide offset Δz in order to satisfy the fiber-to-waveguide alignment condition. In an alternative example, alignment members 42 and 142 can have square cross-sectional shapes with offset respective offset guide holes 44 and 144 to compensate for the fiber-waveguide offset Δz in order to satisfy the fiber-to-waveguide alignment condition.

FIGS. 4E through 4H are similar to FIG. 4B and shows example ferrule assemblies 100 in their assembled form. With reference to FIG. 4E, in an example, ferrule assembly 100 includes a securing member 160 that has an upper surface 162 and a lower surface 164. The securing member 160 resides atop optical fiber array 130 with lower surface 164 in contact with optical fibers 132 to keep the optical fibers in place on upper surface 112 of support substrate 110, as shown in FIGS. 4E and 4F. In an example, securing member 160 is in the form of a planar sheet that has a width WS′ and a height HS′ (FIG. 4B). In an example, the width WS′ is substantially the same as the width WG′ of optical fiber array 130. In an example, with width WS′ is slightly less than the width WG′ of optical fiber array 130. In an example, the width WG′ of optical fiber array 100 is substantially the same as or equal to the edge-to-edge with SE′ of alignment members 142A and 142B, such as shown in example of FIG. 4E. Thus, in an example, optical fiber array 100 spans the entire space between alignment members 142A and 142B. Also in an example, securing member 160 spans the entire space between alignment members 142A and 142B.

In an example, the height HS′ of securing member 160 is relatively small as compared to height h′ of alignment members 142A and 142B, e.g., is in the range from 100 microns to 500 microns. In another example, the height HS′ is substantially the same as or equal to the height h′ of alignment members 142A and 142B, as illustrated in the example shown in FIG. 4G. The configuration of ferrule assembly 100 of FIG. 4G provides ferrule 145 with a solid, block-like structure.

FIG. 4H is similar to FIG. 4F and illustrates an example ferrule assembly 100 wherein securing member 160 includes fiber alignment features 166 on lower surface 164. The fiber alignment features 166 are configured (e.g., shaped) to receive at least a portion of optical fibers 132 and to keep the optical fibers in place and aligned on surface 112 of support substrate 110 so that the end faces 134 of the optical fibers are aligned with the end faces 34 of waveguides 32 of PIC 21 when the ferrule assembly 100 is operably coupled to coupling apparatus 40. In an example, the fiber alignment features 166 are in the form of grooves, such as V-grooves (as shown in FIG. 4F), U-grooves, notches, etc.

In an example, securing member 160 is used as a jig to ensure the proper placement of alignment members 142A and 142B on upper surface 112 of support substrate 110. The securing member 160 can be fixed to optical fiber array 130 and/or to alignment members 142A and 142B using adhesive, such as an epoxy (e.g., a UV-cured epoxy). In another example, securing member 160 can be fixed to alignment members 142A and 142B and/or to optical fiber array 130 using a thin absorbing film or thin film of low melting glass or a glass frit or by using direct glass bonding techniques known in the art.

In an example, support substrate 110 is made of black glass, a glass doped with metal such as iron or titanium, which can facilitate the use of a glass fusion process in assembling ferrule assembly 100. In an example, support substrate 100 can have a layer of glass that has a relatively low melting temperature (i.e., “low-melt glass”), e.g., of about 300 C. This can enable the use of bonding in an oven or other low-temperature non-localized heat source rather than using a laser or other relatively high-temperature and localized heating means to secure alignment members 142A and 142 to upper surface 112 of support substrate 110.

The ferrule 145 of ferrule assembly 100 as disclosed herein can be glass-based or a combination of glass and polymer as part of a “hybrid” configuration, i.e., at least a portion of ferrule 145 is made of at least one type of glass. Thus, embodiments of ferrule assembly 100 are also glass based and can have a hybrid configuration.

In an example, the support substrate 110, alignment members 142A and 142B and the optional securing member 160 of ferrule 145 can be made of glass only, while in another example can be made with only some of the components being glass as part of a “hybrid” configuration. For example, support substrate 110 can be made of glass while alignment members 142A and 142B can be made of a polymer (i.e., a so-called “hybrid” configuration). In another example, ferrule 145 is made of a single type of glass, i.e., all of the components of the ferrule are made of the same glass material. In another example, ferrule 145 is made entirely of glass, but at least some of the components are made of different glass materials—for example, support substrate 110 is made of a first glass material while the two alignment members 142A and 142B are made of a second glass material.

Thus, in an example, optical interface device 200 has a hybrid construction wherein at least a portion of the optical interface device is made of glass since the ferrule assembly 100 and coupling apparatus 40 can each be glass-based, as described above.

Other Example Ferrule Assembly Configurations

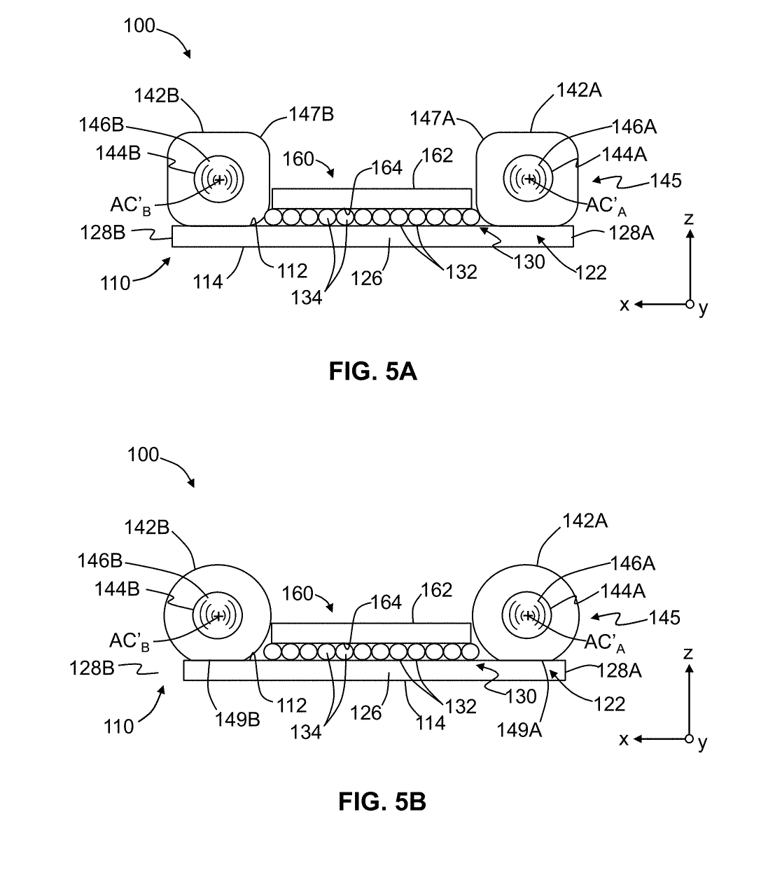

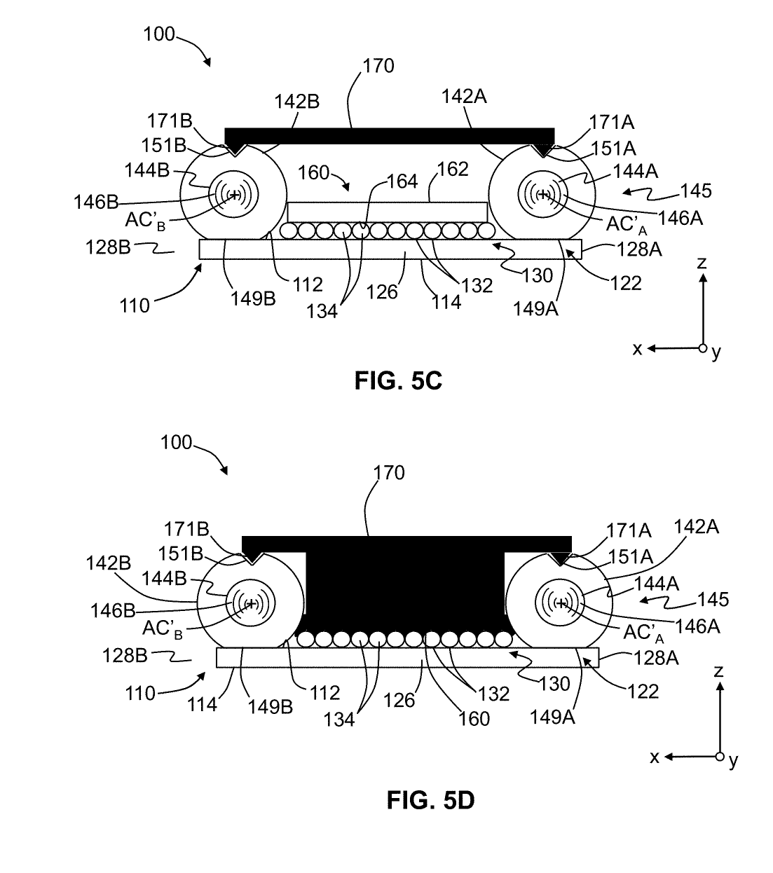

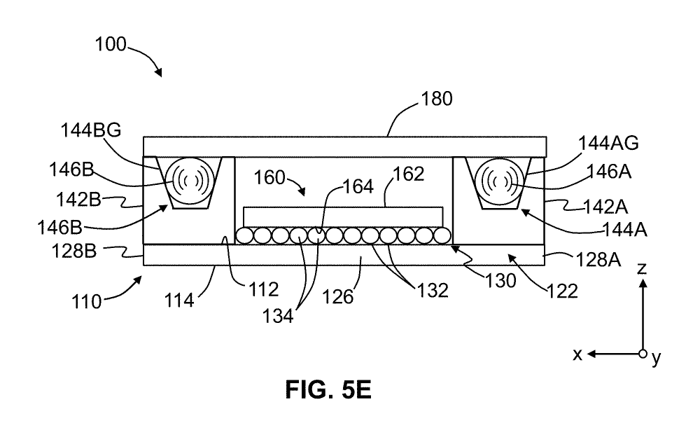

The ferrule assembly 100 disclosed herein can have a number of configurations beyond those example configurations described above. FIGS. 5A through 5E are front-on views of five additional example configurations for ferrule assembly 100 as disclosed herein.

FIG. 5A shows an example ferrule assembly 100 wherein alignment members 142A and 142B have a generally rectangular shape but with respective rounded outer edges 147A and 147B. Such rounded outer edges 147A and 147B can arise for example during a drawing process used to form alignment members 142A and 142B. The rounded outer edges 147A and 1478 can also be obtained by using a molding process or drawing process or extrusion process or 3D printing process to form alignment members 142A and 142B.

FIG. 5B is similar to FIG. 5A and shows an example ferrule assembly 100 wherein alignment members 142A and 142B have a generally circular cross-sectional shape with respective flat sections 149A and 149B for mounting the alignment members to upper surface 112 of support substrate 110. In other words, the flat sections 149A and 149B reside upon upper surface 112. An advantage of having a generally circular cross-sectional shape for alignment members 142A and 142B is that it may be easier to form the alignment members using standard drawing processes such as used in optical fiber manufacturing.

FIG. 5C is similar to FIG. 5B and shows an example ferrule assembly 100 wherein alignment members 142A and 142B have respective alignment features in the form of alignment notches 151A and 151B. The alignment notches 151A and 151B are configured to receive alignment protrusions 171A and 171B of a removable alignment fixture 170. The alignment protrusions 171A and 171B are configured to have a select spacing so that alignment members 142A and 142B can be positioned to have the same select spacing (e.g., center-to-center spacing SC′) prior to being secured to upper surface 112 of support substrate 110. Once alignment members 142A and 142B are aligned and secured to support substrate 110, alignment fixture 170 can be removed from ferrule assembly 100.

FIG. 5D is similar to FIG. 5C and to FIG. 4F and shows an example ferrule assembly 100 wherein the removable alignment fixture 170 is configured to also align optical fibers 132 by aligning securing member 160 on optical fiber array 100. Once alignment members 142A and 142B and optical fibers 132 are aligned and secured to support substrate 110, alignment fixture 170 can be removed from ferrule assembly 100.

FIG. 5E is similar to FIG. 5A and shows an example ferrule assembly 100 wherein the alignment members 142A and 142B have their respective guide holes 144A and 144B defined by respective grooves 144AG and 144BG and an overlying cap member 180. The alignment pins 146 can be arranged in the open grooves 144AG and 144BG and then overlying cap member 180 can be fixed to the alignment members 142A and 142B to form closed guide holes 144A and 144B.

In other examples, alignment members 42 can have the same or substantially the same shapes as the alignment members 142 as described above in connection with example ferrule assemblies 100 of FIGS. 5A through 5E. Thus, in coupling apparatus 40 can also have similar example configurations to the example configurations of ferrule assemblies 100 of FIGS. 5A through 5E.

Photonic System with Connected Optical Interface Device

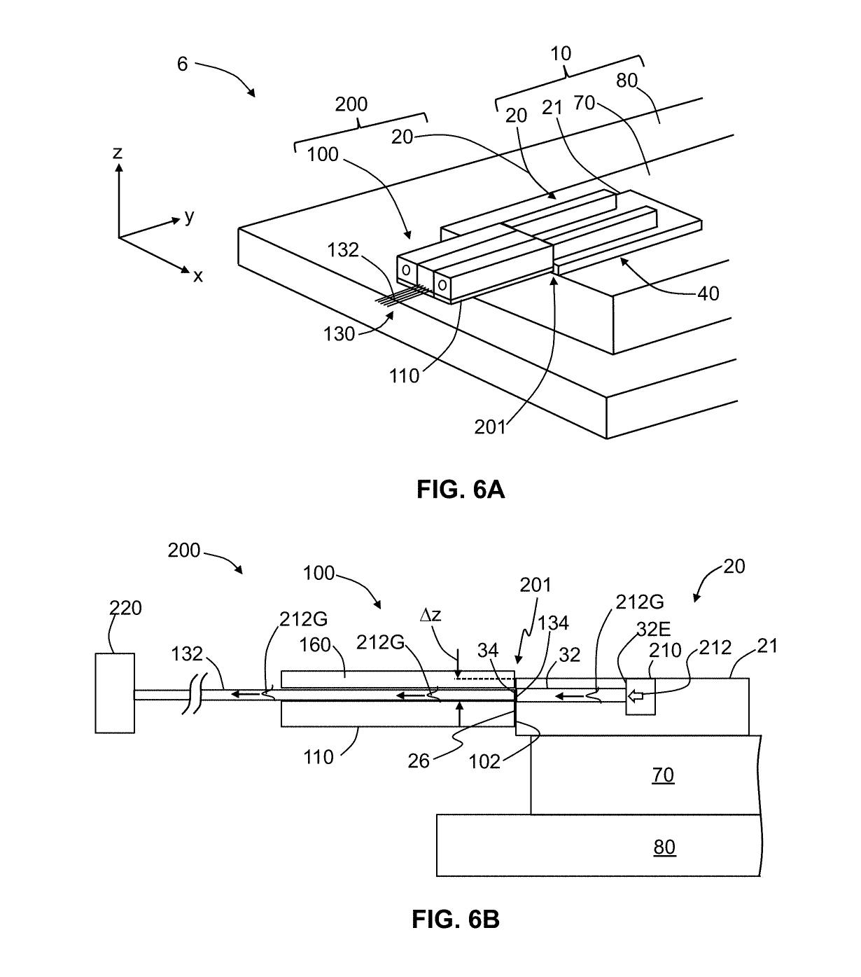

FIG. 6A is similar to FIG. 1A and shows photonic system 6 with optical interface device 200 operably connected, i.e., with ferrule assembly 100 operably coupled to coupling apparatus 40 of PIC assembly 20. The operably coupling is accomplished by alignment pins 146A and 146B of alignment members 142A and 142B of ferrule assembly 100 (see FIGS. 4A, 4B) being received and closely engaged by respective guide holes 44A and 448 of alignment members 42A and 42B of coupling apparatus 40 of PIC assembly 20 (see FIGS. 2A, 28). The optical interface device 200 has an interface 201 defined by the respective confronting front ends 102 and 26 of ferrule assembly 100 and PIC assembly 20.

FIG. 6B is a close-up, cross-sectional view of optical interface device 200 of FIG. 6A as taken in a y-z plane along a waveguide 32 of PIC assembly 20 and a corresponding optical fiber 132 of ferrule assembly 100. FIG. 6B also includes a remote device 220 optical coupled to ferrule assembly 100 via one of optical fibers 132. In FIG. 6B, the mating of alignment pins 146A and 146B with respective guide holes 44A and 44B of alignment members 42A and 42B is not shown because these features are not part of the cross-sectional view.

The PIC 21 of PIC assembly 20 is shown by way of example as having an optical emitter (e.g., light transmitter) 210 optically coupled to an input end 32E of waveguide 32. The optical emitter 210 emits light 212 that enters waveguide 32 at input end 32E and that travels in the waveguide as guided light 212G. The guided light 212G exits waveguide end face 34 of waveguide 32, crosses interface 201 and optical fiber 132 at end face 134. The guided light 212G then travels in optical fiber 132 and is carried away from ferrule assembly 100 to remote device 220.

As noted above, the mating engagement of alignment pins 146A and 146B of alignment members 142A and 142B of ferrule assembly 100 with respective guide holes 44A and 44B of alignment members 42A and 42B of coupling apparatus 40 provides the required axial alignment of waveguides 32 in waveguide array 30 with optical fibers 132 of optical fiber array 130 in the connected optical interface device 200. This allows for optical communication to take place between PIC assembly 20 and remote device 220. This optical communication includes sending information as embodied in guided light 212G, which in an example comprises optical signals. In other examples, the optical communication can be in the reverse direction in the case where the optical device 210 includes an optical transmitter and wherein the optical emitter 210 is an optical detector (e.g., photodetector).

In an example, waveguides 32 and optical fibers 132 have the same or substantially similar sizes and the same pitches p and p′ (to within manufacturing tolerances) to optimize the optical coupling efficiency (i.e., to minimize optical loss) between the waveguides and the optical fibers. In an example, waveguides 32 and optical fibers 132 are both single mode and the guided light 212G carried by each has substantially the same mode-field diameter.

Features and Advantages

The embodiments of PIC assembly 20 and ferrule assembly 100 offer a number of important features and advantages as compared to existing PIC and ferrule assemblies and optical interface devices. A first advantage is that the glass-based construction of coupling apparatus 40 and ferrule assembly 100 avoids a substantial mismatch of the coefficients of thermal expansion (CTEs) between the two assemblies when they are operably coupled to one another. The coupling between fibers and waveguides can also occur over a broad optical wavelength range.

The ferrule assemblies and the coupling apparatus disclosed herein can also be made about twice as small as conventional ferrule assemblies and coupling apparatus that utilize standard sized connector components. The use of small-clad optical fibers 132 allows for a reduced optical fiber pitch p′ and allows for greater ability to match the waveguide pitch p of PIC 21.

In addition, optical interface device 200 has a side-mount configuration because ferrule assembly 100 and PIC assembly 20 are engaged at their front “sides” (i.e., at their respective front ends 102 and 26). A side-mount configuration has advantages over a top-mount configuration, which presents the risk of damage to PIC 21. It also allows for a small form factor in the vertical (z) direction.

It will be apparent to those skilled in the art that various modifications to the preferred embodiments of the disclosure as described herein can be made without departing from the spirit or scope of the disclosure as defined in the appended claims. Thus, the disclosure covers the modifications and variations provided they come within the scope of the appended claims and the equivalents thereto.

What is claimed is:

1. A ferrule assembly for optically coupling to a coupling apparatus of a photonic-integrated-circuit (PIC) assembly, comprising:
a glass support substrate having opposite upper and lower surfaces, opposite sides, and opposite front and back ends;
first and second alignment members having respective first and second long axes and that are attached to the upper surface and spaced apart along their long axes, the first and second alignment members having respective first and second alignment features that respectively operably engage with first and second complementary alignment features of the coupling apparatus; and
an array of optical fibers disposed on the upper surface of the glass support substrate between the first and second support members, with the optical fibers having end faces that reside substantially at the front end of the support substrate.

2. The ferrule assembly according to claim 1, wherein each of the first and second alignment members has a cross-sectional height (h′) and a width (w′) that define an aspect ratio of h′:w′, the aspect ratio that is no greater than 1:5 or no greater than 5:1.

3. The ferrule assembly according to claim 2, wherein h′ and w′ are each in the range from 300 microns to 2000 microns.

4. The ferrule assembly according to claim 1, wherein the ferrule assembly has dimensions including an overall height (HT′), an overall width (WT′) and an overall length (LT′), and wherein HT′ is between 1 millimeters and 5 millimeters, WT′ is between 3 millimeters and 15 millimeters and LT′ is between 2 millimeters and 20 millimeters.

5. The ferrule assembly according to claim 1, wherein the first and second alignment members comprise a non-glass material.

6. The ferrule assembly according to claim 1, wherein the first and second alignment members comprise a glass.

7. The ferrule assembly according to claim 6, wherein the glass of the first and second alignment members has a different glass composition than the glass support substrate or the first and second alignment members are created by a different glass forming process than the glass support substrate.

8. The ferrule assembly according to claim 1, further comprising a securing member arranged atop the optical fiber array.

9. The ferrule assembly according to claim 8, wherein the securing member has a lower surface that includes fiber alignment features for aligning the optical fibers on the upper surface of the support substrate.

10. The ferrule assembly according to claim 8, wherein the securing member comprises a glass.

11. The ferrule assembly according to claim 1, wherein the first and second alignment members each include a third alignment feature used to align the first and second alignment members on the glass support substrate.

12. The ferrule assembly according to claim 1, wherein the first and second alignment members each have a substantially square cross-sectional shape.

13. The ferrule assembly according to claim 1, wherein the optical fibers are single-mode optical fibers.

14. The ferrule assembly according to claim 1, further comprising a support structure that mechanically connects the first and second alignment members.

15. The ferrule assembly according to claim 1, wherein the first and second alignment features respectively comprise either first and second guide holes or first and second alignment pins.

16. An optical interface device, comprising:
the ferrule assembly according to claim 1; and
a photonic integrated circuit (PIC) assembly configured to operably couple to the ferrule assembly.

17. The optical interface device according to claim 16, wherein the first and second alignment members of the ferrule assembly have a same cross-sectional geometry as third and fourth alignment members of the coupling apparatus.

18. The optical interface device according to claim 17, wherein the third and fourth alignment members are rotated by 90 degrees relative to the first and second alignment members.

19. A photonic system, comprising:
the optical interface device according to claim 16;
a printed circuit board to which the PIC assembly is electrically connected; and
a remote device operably connected to at least one of the optical fibers of the ferrule assembly.

20. A photonic-integrated-circuit (PIC) assembly configured to couple to a ferrule assembly, comprising:
a PIC having an upper surface, a front end, and an array of optical waveguides, with each optical waveguide having an end face that resides substantially at the PIC front end; and
first and second alignment members having respective first and second front ends and first and second long axes, the first and second alignment members being attached to the upper surface and spaced apart along the first and second long axes, the first and second alignment members having respective first and second alignment features that respectively operably engage with first and second complementary alignment features of the ferrule assembly.
